(19) United States
(12) Patent Application Publication
(10) Pub. No.: US 2026/0369990 A1
(43) Pub. Date: Nov. 19, 2026

(54) INRUSH CURRENT SUPPRESSION CIRCUIT HAVING RAMP VOLTAGE PULL-DOWN MECHANISM

(71) Applicant: ANPEC ELECTRONICS CORPORATION, HSINCHU (TW)

(72) Inventors: YI-CHUAN LU, HSINCHU (TW); CHIH-NING CHEN, TAIPEI CITY (TW); CHIH-HENG SU, Hsinchu City (TW)

(21) Appl. No.: 19/347,676

(22) Filed: Oct. 1, 2025

(30) Foreign Application Priority Data
May 15, 2025 (TW) 114118186

(51) Int. Cl. H02H 9/00; H02H 9/02

(52) U.S. Cl. CPC H02H 9/001; H02H 9/025

(57) ABSTRACT

An inrush current suppression circuit having a ramp voltage pull-down mechanism includes a load switch, a switch control circuit, a modulation transistor and a comparing circuit. A first terminal of the modulation transistor is connected to a ramp node. The ramp node is coupled to a ramp voltage being increased over time. A second terminal of the modulation transistor is grounded. When an output voltage of a second terminal of the load switch is lower than a reference voltage, the comparing circuit turns on the modulation transistor for pulling down the ramp voltage at the ramp node. The switch control circuit output a control current to a control terminal of the load switch according to the output voltage of the second terminal of the load switch and the ramp voltage from the ramp node.

### CROSS-REFERENCE TO RELATED PATENT APPLICATION

This application claims the benefit of priority to Taiwan Patent Application No. 114118186, filed on May 15, 2025. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to an inrush current, and more particularly to an inrush current suppression circuit having a ramp voltage pull-down mechanism.

### BACKGROUND OF THE DISCLOSURE

In order to stably turn on a load switch, soft start of the load switch must be performed. In the soft start of the load switch, a voltage of a control terminal of the load switch is gradually increased. The load switch is unable to supply an output voltage to a load until the voltage of the control terminal of the load switch is higher than a threshold voltage of the load switch.

However, when the voltage of the control terminal of the load switch is gradually increased, a voltage difference between a divided voltage of the output voltage of the second terminal of the load switch and a ramp voltage becomes excessively large. At this time, in order to quickly increase the divided voltage to reach the ramp voltage, the load switch is controlled to supply a larger current for short periods of time by an amplifier. At this time, the output voltage of the second terminal of the load switch rises abruptly rather than smoothly. As a result, inrush waves are generated in an output current of the second terminal of the load switch, which in turn trigger an overcurrent protection device to disable the load switch from being turned on.

### SUMMARY OF THE DISCLOSURE

In response to the above-referenced technical inadequacies, the present disclosure provides an inrush current suppression circuit having a ramp voltage pull-down mechanism. The inrush current suppression circuit includes a load switch, a switch control circuit and a ramp voltage modulating circuit. A first terminal of the load switch is coupled to an input voltage. The switch control circuit is connected to a control terminal and a second terminal of the load switch. The switch control circuit is connected to a ramp node. The ramp node is coupled to a ramp voltage being increased over time. The switch control circuit is configured to output a control signal to the control terminal of the load switch, according to an output voltage of the second terminal of the load switch and the ramp voltage from the ramp node. The ramp voltage modulating circuit includes a modulation transistor and a comparing circuit. A first terminal of the modulation transistor is connected to the ramp node. A second terminal of the modulation transistor is grounded. The comparing circuit is connected to the second terminal of the load switch and a control terminal of the modulation transistor. The comparing circuit is configured to turn on the modulation transistor for pulling down the ramp voltage of the ramp node when the output voltage of the second terminal of the load switch is lower than a reference voltage.

In order to solve the above-mentioned problems, one of the technical aspects adopted by the present disclosure is to provide an inrush current suppression circuit having the ramp voltage pull-down mechanism. The inrush current suppression circuit includes a load switch, a voltage dividing circuit, a switch control circuit and a ramp voltage modulating circuit. A first terminal of the load switch is coupled to an input voltage. The voltage dividing circuit is connected to a second terminal of the load switch. The voltage dividing circuit is configured to divide an output voltage of the second terminal of the load switch to output a divided voltage. The switch control circuit is connected to a control terminal of the load switch, the voltage dividing circuit and a ramp node. The ramp node is coupled to a ramp voltage being increased over time. The switch control circuit is configured to output a control signal to the control terminal of the load switch, according to the ramp voltage and the divided voltage. The ramp voltage modulating circuit includes a modulation transistor and a comparing circuit. A first terminal of the modulation transistor is connected to the ramp node. A second terminal of the modulation transistor is grounded. The comparing circuit is connected to the voltage dividing circuit and a control terminal of the modulation transistor. The comparing circuit is configured to turn on the modulation transistor for pulling down the ramp voltage of the ramp node when the divided voltage is lower than a reference voltage.

As described above, the present disclosure provides the inrush current suppression circuit having the ramp voltage pull-down mechanism. In the inrush current suppression circuit of the present disclosure, when the output voltage of the load switch is initially increased, the ramp voltage modulating circuit pulls down the ramp voltage that is received from the ramp node by the switch control circuit for reducing the voltage difference between the output voltage and the ramp voltage. As a result, the switch control circuit is prevented from causing inrush waves in an output current of the load switch in order to quickly increase the output voltage to be equal to or higher than the ramp voltage. Therefore, if the inrush current suppression circuit of the present disclosure is applied to the load switch, the switch control circuit and other external overcurrent protection devices are not triggered to perform an overcurrent protection process which causes the load switch to become ineffective or unable to be turned on.

These and other aspects of the present disclosure will become apparent from the following description of the embodiment taken in conjunction with the following drawings and their captions, although variations and modifications therein may be effected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a circuit diagram of an inrush current suppression circuit having a ramp voltage pull-down mechanism according to a first embodiment of the present disclosure;

FIG. 2 is a circuit diagram of a ramp voltage modulating circuit of an inrush current suppression circuit having a ramp voltage pull-down mechanism according to a second embodiment of the present disclosure;

FIG. 3 is a circuit diagram of a ramp voltage modulating circuit of an inrush current suppression circuit having a ramp voltage pull-down mechanism according to a third embodiment of the present disclosure;

FIG. 4 is a circuit diagram of an inrush current suppression circuit having a ramp voltage pull-down mechanism according to a fourth embodiment of the present disclosure;

FIG. 5 is a circuit diagram of an inrush current suppression circuit having a ramp voltage pull-down mechanism according to a fifth embodiment of the present disclosure;

FIG. 6 is a circuit diagram of an inrush current suppression circuit having a ramp voltage pull-down mechanism according to a sixth embodiment of the present disclosure;

FIG. 7 is a circuit diagram of an inrush current suppression circuit having a ramp voltage pull-down mechanism according to a seventh embodiment of the present disclosure;

FIG. 8 is a circuit diagram of an inrush current suppression circuit having a ramp voltage pull-down mechanism according to an eighth embodiment of the present disclosure;

FIG. 9 is a waveform diagram of the inrush current suppression circuit having the ramp voltage pull-down mechanism according to the sixth to eighth embodiments of the present disclosure; and

FIG. 10 is a waveform diagram of the inrush current suppression circuit having the ramp voltage pull-down mechanism according to the sixth to eighth embodiments of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

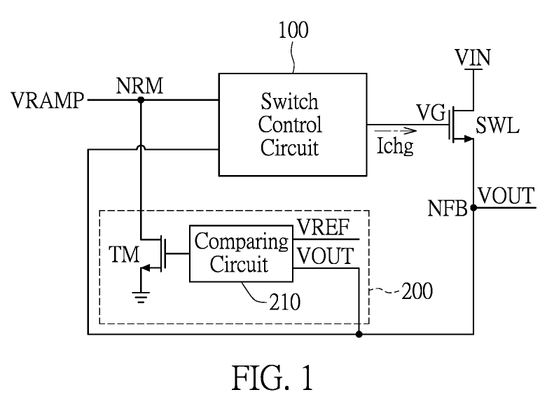

Reference is made to FIG. 1, which is a circuit diagram of an inrush current suppression circuit having a ramp voltage pull-down mechanism according to a first embodiment of the present disclosure.

As shown in FIG. 1, the inrush current suppression circuit of the present disclosure includes a load switch SWL, a switch control circuit 100 and a ramp voltage modulating circuit 200.

A first terminal of the load switch SWL is coupled to an input voltage VIN. A second terminal of the load switch SWL is used as an output terminal of the load switch SWL and configured to supply an output voltage VOUT. The load switch SWL may be coupled to a load. The load receives the output voltage VOUT from the second terminal of the load switch SWL or receives an output current from the output voltage VOUT.

The second terminal of the load switch SWL is used as a feedback node NFB and connected to a first input terminal of the switch control circuit 100.

A second input terminal of the switch control circuit 100 is connected to a ramp node NRM. The ramp node NRM is coupled to a ramp voltage VRAMP being increased over time. An output terminal of the switch control circuit 100 is connected to a control terminal of the load switch SWL.

The switch control circuit 100, according to (a voltage difference between) the output voltage VOUT of the second terminal of the load switch SWL and the ramp voltage VRAMP, sets and outputs a control signal (including a control current Ichg) to the control terminal of the load switch SWL for controlling operation of the load switch SWL.

For example, the switch control circuit 100 may compare the output voltage VOUT from the second terminal of the load switch SWL with the ramp voltage VRAMP from the ramp node NRM. The switch control circuit 100 may determine whether or not the output voltage VOUT of the second terminal of the load switch SWL is higher than the ramp voltage VRAMP, or calculate the voltage difference between the output voltage VOUT of the second terminal of the load switch SWL and the ramp voltage VRAMP and determine whether the voltage difference is higher than a voltage difference threshold, to generate a compared result. The switch control circuit 100 may determine whether to output the control current Ichg to the control terminal of the load switch SWL, or set a current value of the control current Ichg and output the control current Ichg to the control terminal of the load switch SWL.

It should be understood that, in order to stably turn on the load switch SWL, soft start of the load switch SWL must be performed. However, the output voltage of the second terminal of the load switch SWL has a low initial voltage value. When a conventional switch control circuit performs soft start of the load switch SWL, a voltage of a control terminal of the load switch SWL is slowly increased from the low initial voltage value to a threshold voltage for turning on the load switch SWL over a long period of time, within which a high voltage difference is generated between the output voltage and the ramp voltage. The conventional switch control circuit, in order to quickly supply an output voltage for operation of a load, instantly or continuously supplies a control voltage having a high voltage value or a charging current having a large current value to the control terminal of the load switch SWL for turning on the load switch SWL earlier. As a result, inrush waves are generated in the output current of the second terminal of the load switch SWL controlled by the conventional switch control circuit.

It is worth noting that, in order to prevent the inrush waves from being generated in the output current of the second terminal of the load switch SWL, the inrush current suppression circuit of the present disclosure not only includes the load switch SWL and the switch control circuit 100, but further includes the ramp voltage modulating circuit 200. The ramp voltage modulating circuit 200 includes a modulation transistor TM and a comparing circuit 210.

A first terminal of the modulation transistor TM is connected to the ramp node NRM between the ramp voltage VRAMP and the first input terminal of the switch control circuit 100. A second terminal of the modulation transistor TM is grounded.

A first input terminal of the comparing circuit 210 is connected to the second terminal of the load switch SWL. A second input terminal of the comparing circuit 210 is coupled to a reference voltage VREF. An output terminal of the comparing circuit 210 is connected to a control terminal of the modulation transistor TM.

The comparing circuit 210 compares the output voltage VOUT of the second terminal of the load switch SWL with the reference voltage VREF to generate a comparison signal, and outputs a ramp control signal to the control terminal of the modulation transistor TM according to the comparison signal.

That is, in the inrush current suppression circuit of the present disclosure, the comparing circuit 210 of the ramp voltage modulating circuit 200, according to the comparison signal of the output voltage VOUT of the second terminal of the load switch SWL with the reference voltage VREF, controls an operational state of the modulation transistor TM so as to modulate a voltage value of the ramp voltage VRAMP received by the second input terminal of the switch control circuit 100.

For example, when the output voltage VOUT of the second terminal of the load switch SWL is lower than the reference voltage VREF, the comparing circuit 210 turns on the modulation transistor TM for pulling down the ramp voltage VRAMP of the second input terminal of the switch control circuit 100. Then, when the ramp voltage VRAMP of the second input terminal of the switch control circuit 100 is increased over time and the output voltage VOUT of the second terminal of the load switch SWL is slowly increased from an initial voltage value, the ramp voltage modulating circuit 200 pulls down the ramp voltage VRAMP for reducing the voltage difference between the output voltage VOUT and the ramp voltage VRAMP. As a result, no inrush wave is generated in the output current of the second terminal of the load switch SWL.

Then, when the output voltage VOUT of the second terminal of the load switch SWL is gradually increased to be higher than the reference voltage VREF, the comparing circuit 210 turns off the modulation transistor TM to stop pulling down the ramp voltage VRAMP of the second input terminal of the switch control circuit 100. At this time, the output voltage VOUT of the second terminal of the load switch SWL and the ramp voltage VRAMP are gradually increased at the same time. The voltage difference between the output voltage VOUT of the second terminal of the load switch SW and the ramp voltage VRAMP is maintained to be lower than the voltage difference threshold.

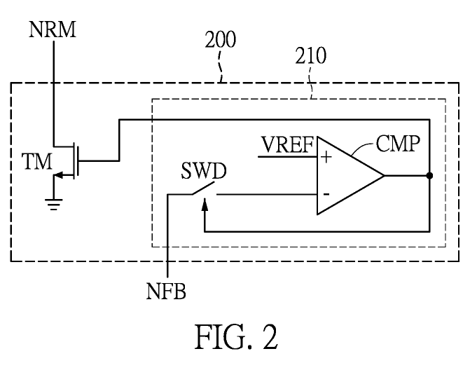

Reference is made to FIG. 2, which is a circuit diagram of a ramp voltage modulating circuit of an inrush current suppression circuit having a ramp voltage pull-down mechanism according to a second embodiment of the present disclosure.

The ramp voltage modulating circuit 200 shown in FIGS. 1 and 4-8 may be replaced with that shown in FIG. 2.

As shown in FIG. 2, the ramp voltage modulating circuit 200 includes the modulation transistor TM and the comparing circuit 210. The comparing circuit 210 includes a comparator CMP and a feedback switch SWD.

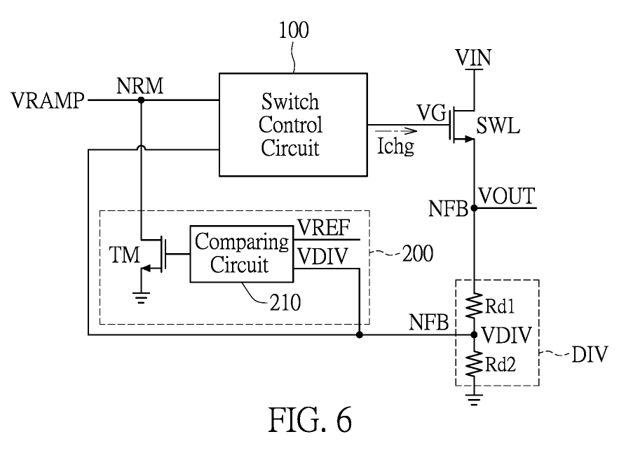

The second terminal of the load switch SWL shown in FIGS. 1, 4 or 5 or the output terminal of the voltage dividing circuit DIV shown in FIGS. 6-8 is used as the feedback node NFB and connected to a first terminal of the feedback switch SWD shown in FIG. 2.

A second terminal of the feedback switch SWD is connected to a first input terminal such as an inverting input terminal of the comparator CMP. A second input terminal such as an inverting input terminal off the comparator CMP is coupled to the reference voltage VREF.

An output terminal of the comparator CMP is connected to the control terminal of the modulation transistor TM and the control terminal of the feedback switch SWD.

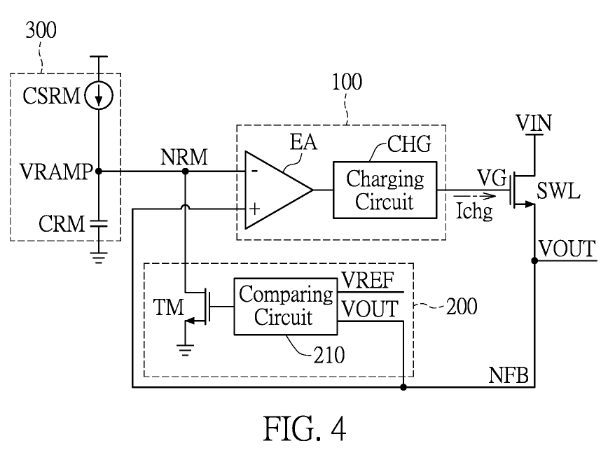

The first terminal of the modulation transistor TM shown in FIG. 2 is connected to the ramp node NRM between the ramp voltage VRAMP and the first input terminal of the switch control circuit 100 as shown in FIGS. 1 or 6, or is connected to the ramp node NRM between a ramp voltage generating circuit 300 shown in FIGS. 4, 5, 7 or 8 and the first input terminal of the switch control circuit 100.

When the feedback switch SWD is turned on, the comparator CMP obtains the output voltage VOUT of the second terminal of the load switch SWL shown in FIGS. 1, 4, 5 from the feedback node NFB, or obtains a divided voltage VDIV of the output voltage VOUT as shown in FIGS. 6 to 8. Then, the comparator CMP compares the output voltage VOUT (or the divided voltage VDIV) with the reference voltage VREF to generate the comparison signal, and outputs the ramp control signal respectively to the control terminal of the modulation transistor TM and the control terminal of the feedback switch SWD.

The modulation transistor TM and the feedback switch SWD operate according to the comparison signal from the output terminal of the comparator CMP.

For example, when the output voltage VOUT of the second terminal of the load switch SWL (or the divided voltage VDIV thereof) is lower than the reference voltage VREF, the output terminal of the comparator CMP outputs the comparison signal at a first level (such as a high level) respectively to the control terminal of the modulation transistor TM and the control terminal of the feedback switch SWD. Under this condition, the modulation transistor TM and the feedback switch SWD are turned on. At this time, the ramp node NRM is connected to a ground through the modulation transistor TM being turned on. As a result, a voltage of the second input terminal of the switch control circuit 100 is pulled down from the ramp voltage VRAMP received from the ramp node NRM such that the voltage difference between the ramp voltage VRAMP and the output voltage VOUT is reduced.

Conversely, when the output voltage VOUT of the second terminal of the load switch SWL (or the divided voltage VDIV thereof) is higher than the reference voltage VREF, the output terminal of the comparator CMP outputs the comparison signal at an initial level (such as a low level) respectively to the control terminal of the modulation transistor TM and the control terminal of the feedback switch SWD. Under this condition, the modulation transistor TM and the feedback switch SWD are turned off to stop pulling down the ramp voltage VRAMP.

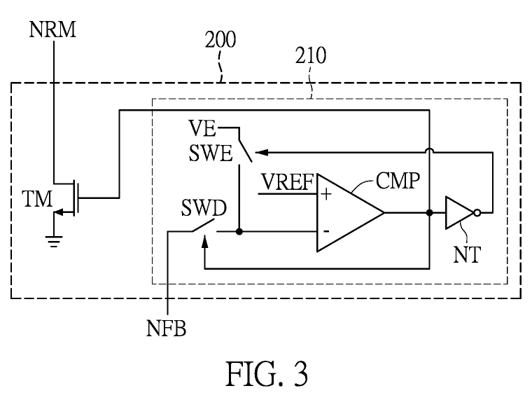

Reference is made to FIG. 3, which is a circuit diagram of a ramp voltage modulating circuit of an inrush current suppression circuit having a ramp voltage pull-down mechanism according to a third embodiment of the present disclosure.

The ramp voltage modulating circuit 200 shown in FIGS. 1 and 4-8 may be replaced with that shown in FIG. 3. As shown in FIG. 3, the ramp voltage modulating circuit 200 includes the modulation transistor TM and the comparing circuit 210.

The descriptions of the third embodiment of the present disclosure that are the same the descriptions of the second embodiment of the present disclosure are not repeated herein.

Differences between the third and second embodiments are not described as below.

In order to keep the comparator CMP in an operating state and make the inrush current suppression circuit of the present disclosure more stable, as shown in FIG. 3, in the third embodiment, the comparing circuit 210 of the ramp voltage modulating circuit 200 not only includes the comparator CMP and the feedback switch SWD, but further includes an inverter NT and an enable switch SWE.

An input terminal of the inverter NT is connected to the output terminal of the comparator CMP.

An output terminal of the inverter NT is connected to a control terminal of the enable switch SWE.

A first terminal of the enable switch SWE is coupled to an enable voltage VE. A second terminal of the enable switch SWE is connected to the first input terminal such as the inverting input terminal of the comparator CMP. The enable switch SWE is higher than the reference voltage VREF received by the second input terminal such as the non-inverting input terminal of the comparator CMP.

When the output terminal of the comparator CMP outputs the comparison signal at the high level to the control terminal of the feedback switch SWD, the feedback switch SWD is turned on such that the first input terminal of the comparator CMP receives the output voltage VOUT of the second terminal of the load switch SWL (or the divided voltage VDIV thereof) from the feedback node NFB through the feedback switch SWD. At the same time, the input terminal of the inverter NT receives the comparison signal at the high level from the output terminal of the comparator CMP, and the inverter NT inverts the comparison signal at the high level into the comparison signal at the low level and outputs the comparison signal at the low level to the control terminal of the enable switch SWE. As a result, the enable switch SWE is turned off.

Conversely, when the output terminal of the comparator CMP outputs the comparison signal at the low level to the control terminal of the enable switch SWE, the feedback switch SWD is turned off. At this time, the first input terminal such as the inverting input terminal of the comparator CMP cannot receive the output voltage VOUT of the second terminal of the load switch SWL (or the divided voltage VDIV thereof) from the feedback node NFB. In order to prevent operation of the comparator CMP from being stopped due to a voltage of the first input terminal of the comparator CMP is reduced to a zero voltage value, the output terminal of the comparator CMP outputs the comparison signal at the low level to the input terminal of the inverter NT, and then the inverter NT inverts the comparison signal at the low level into the comparison signal at the high level and outputs the comparison signal at the high level to the control terminal of the enable switch SWE. As a result, the enable switch SWE is turned on such that the enable voltage VE is inputted to the first input terminal of the comparator CMP through the enable switch SWE. Therefore, the comparator CMP continually compares the enable switch SWE received by the first input terminal of the comparator CMP with the reference voltage VREF received by the second input terminal of the comparator CMP.

Reference is made to FIG. 4, which is a circuit diagram of an inrush current suppression circuit having a ramp voltage pull-down mechanism according to a fourth embodiment of the present disclosure.

The descriptions of the fourth embodiment of the present disclosure that are the same as the descriptions of the first embodiment of the present disclosure are not repeated herein.

A difference between the fourth and first embodiments of the present disclosure is that, as shown in FIG. 4, in the fourth embodiment, the inrush current suppression circuit of the present disclosure not only includes the load switch SWL, the switch control circuit 100 and the ramp voltage modulating circuit 200, but further includes the ramp voltage generating circuit 300.

In addition, the switch control circuit 100 includes an error amplifier EA and a charging circuit CHG. In practice, the switch control circuit 100 shown in FIGS. 1 and 6 may be replaced with that shown in FIG. 4.

A first input terminal such as a non-inverting input terminal of the error amplifier EA is connected to the second terminal of the load switch SWL, and receives the output voltage VOUT from the second terminal of the load switch SWL.

A second input terminal such as an inverting input terminal of the error amplifier EA and the ramp voltage generating circuit 300 are connected to the ramp node NRM.

The ramp voltage generating circuit 300 generates the ramp voltage VRAMP and outputs the ramp voltage VRAMP to the ramp node NRM. The second input terminal such as the inverting input terminal of the error amplifier EA receives the ramp voltage VRAMP from the ramp node NRM.

For example, the ramp voltage generating circuit 300 includes a ramp capacitor CSRM and a ramp current source CRM. A first terminal of the ramp capacitor CSRM is connected to the ramp node NRM. A second terminal of the ramp capacitor CSRM is grounded. The ramp current source CRM is connected to the ramp capacitor CSRM.

The ramp current source CRM supplies a ramp current to the ramp capacitor CSRM for charging the ramp capacitor CSRM such that the ramp voltage VRAMP of the first terminal of the ramp capacitor CSRM is increased over time. The second input terminal such as the inverting input terminal of the error amplifier EA receives the ramp voltage VRAMP being increased over time from the ramp node NRM.

The error amplifier EA multiplies the voltage difference between the output voltage VOUT of the second terminal of the load switch SWL and the ramp voltage VRAMP by a gain to output an error amplified signal.

The charging circuit CHG is connected to an output terminal of the error amplifier EA. The charging circuit CHG sets a current value of the control current Ichg according to a voltage of the error amplified signal from the output terminal of the error amplifier EA, or converts the voltage of the error amplified signal into a current value. The charging circuit CHG outputs the control current Ichg having the current value that is set or converted to the control terminal of the load switch SWL for controlling operation of the load switch SWL.

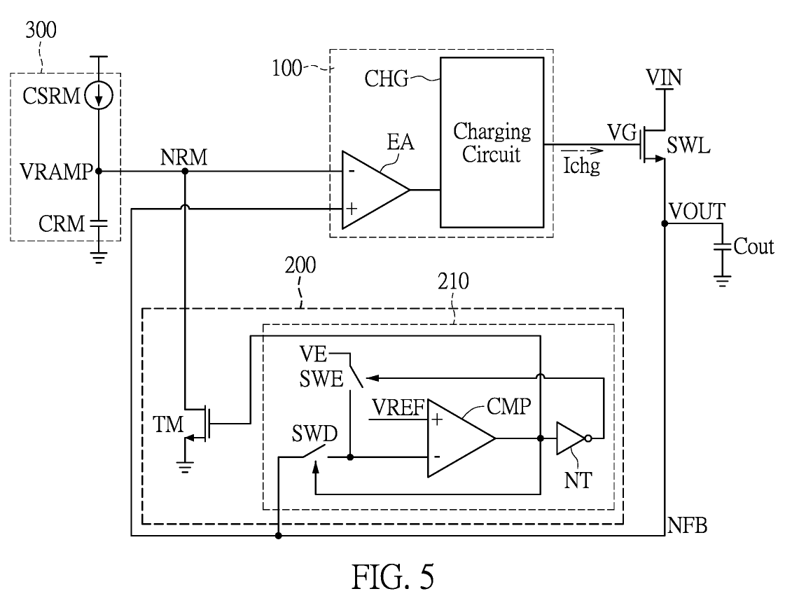

Reference is made to FIG. 5, which is a circuit diagram of an inrush current suppression circuit having a ramp voltage pull-down mechanism according to a fifth embodiment of the present disclosure.

The descriptions of the fifth embodiment of the present disclosure that are the same as the descriptions of the first to fourth embodiments are not repeated therein. A difference between the fifth and fourth embodiments is that, as shown in FIG. 5, in the fifth embodiment, the comparing circuit 210 includes the comparator CMP, the feedback switch SWD, the inverter NT and the enable switch SWE, which are the same as that shown in FIG. 3.

If necessary, the inrush current suppression circuit of the present disclosure may further include an output capacitor Cout. A first terminal of the output capacitor Cout is connected to the second terminal of the load switch SWL, and receives the output voltage VOUT or the output current from the second terminal of the load switch SWL. The first terminal of the output capacitor Cout may be further connected to the load. A second terminal of the output capacitor Cout is grounded. The load receives a voltage or a discharging current from the first terminal of the output capacitor Cout.

Reference is made to FIG. 6, which is a circuit diagram of an inrush current suppression circuit having a ramp voltage pull-down mechanism according to a sixth embodiment of the present disclosure.

The descriptions of the sixth embodiment of the present disclosure that are the same as the descriptions of the present disclosure are not repeated herein. A difference between the sixth and first embodiments is that, as shown in FIG. 6, in the sixth embodiment, the inrush current suppression circuit of the present disclosure not only includes the load switch SWL, the switch control circuit 100 and the ramp voltage modulating circuit 200, but further includes the voltage dividing circuit DIV.

The voltage dividing circuit DIV is connected between the second terminal of the load switch SWL and the first input terminal of the switch control circuit 100, and between the second terminal of the load switch SWL and the first input terminal of the comparing circuit 210.

The voltage dividing circuit DIV is configured to divide the output voltage VOUT of the second terminal of the load switch SWL to output the divided voltage VDIV respectively to the first input terminal of the switch control circuit 100 and the first input terminal of the comparing circuit 210.

For example, the voltage dividing circuit DIV includes a first voltage dividing resistor Rd1 and a second voltage dividing resistor Rd2. A first terminal of the first voltage dividing resistor Rd1 is connected to the second terminal of the load switch SWL. A first terminal of the second voltage dividing resistor Rd2 is connected to a second terminal of the first voltage dividing resistor Rd1. A second terminal of the second voltage dividing resistor Rd2 is grounded. In the sixth embodiment, a node between the first terminal of the second voltage dividing resistor Rd2 and the second terminal of the first voltage dividing resistor Rd is used as the feedback node NFB, and a voltage of the feedback node NFB is the divided voltage VDIV of the output voltage VOUT of the second terminal of the load switch SWL.

The feedback node NFB between the first terminal of the second voltage dividing resistor Rd2 and the second terminal of the first voltage dividing resistor Rd is connected to the first input terminal of the switch control circuit 100 and the first input terminal of the comparing circuit 210.

The comparing circuit 210 compares the divided voltage VDIV from the feedback node NFB with the reference voltage VREF to generate the comparison signal, and outputs the ramp control signal to the control terminal of the modulation transistor TM for controlling the operational state of the modulation transistor TM so as to control the ramp voltage VRAMP of the ramp node NRM.

The switch control circuit 100 sets the current value of the control current Ichg, according to a relationship between the divided voltage VDIV from the feedback node NFB of the voltage dividing circuit DIV and the ramp voltage VRAMP from the ramp node NRM. The relationship may include a voltage difference, an amplified voltage difference that is the voltage difference multiplied by a gain or the comparison signal. The switch control circuit 100 and outputs the control current Ichg to the control terminal of the load switch SWL.

For example, when the divided voltage VDIV of the output voltage VOUT of the second terminal of the load switch SWL is lower than the reference voltage VREF, the output terminal of the comparator CMP outputs the comparison signal at the first level (such as the high level) respectively to the control terminal of the modulation transistor TM and the control terminal of the feedback switch SWD. Under this condition, the modulation transistor TM and the feedback switch SWD are turned on. The ramp node NRM is connected to the ground through the modulation transistor TM. As a result, the voltage of the second input terminal of the switch control circuit 100 is pulled down from the ramp voltage VRAMP received from the ramp node NRM, such that the voltage difference between the ramp voltage VRAMP and the output voltage VOUT is reduced.

Conversely, when the output voltage VOUT of the second terminal of the load switch SWL is gradually increased such that the divided voltage VDIV of the output voltage VOUT is gradually increased to be higher than the reference voltage VREF, the output terminal of the comparator CMP outputs the comparison signal at the initial level (such as the low level) respectively to the control terminal of the modulation transistor TM and the control terminal of the feedback switch SWD. Under this condition, the modulation transistor TM and the feedback switch SWD are turned off to stop pulling down the ramp voltage VRAMP.

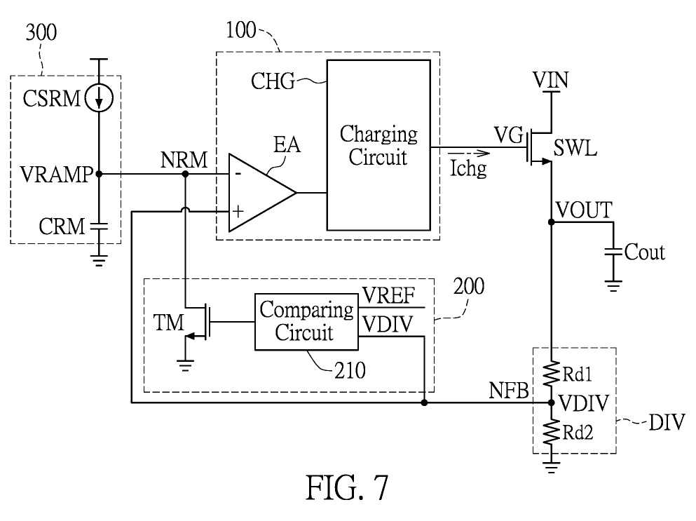

Reference is made to FIG. 7, which is a circuit diagram of an inrush current suppression circuit having a ramp voltage pull-down mechanism according to a seventh embodiment of the present disclosure.

As shown in FIG. 7, in the seventh embodiment, the inrush current suppression circuit of the present disclosure includes the load switch SWL, the switch control circuit 100, the ramp voltage modulating circuit 200, the ramp voltage generating circuit 300, the voltage dividing circuit DIV and the output capacitor Cout.

The switch control circuit 100 shown in FIG. 7 is the same as that shown in FIG. 5. The ramp voltage modulating circuit 200 shown in FIG. 7 is the same as that shown in FIG. 1. The ramp voltage generating circuit 300 shown in FIG. 7 is the same as that shown in FIG. 5. The voltage dividing circuit DIV shown in FIG. 7 is the same as that shown in FIG. 6. The output capacitor Cout shown in FIG. 7 is the same as that shown in FIG. 5. The descriptions of the seventh embodiment of the present disclosure that are the same as of the descriptions of the first to sixth embodiments of the present disclosure are not repeated herein.

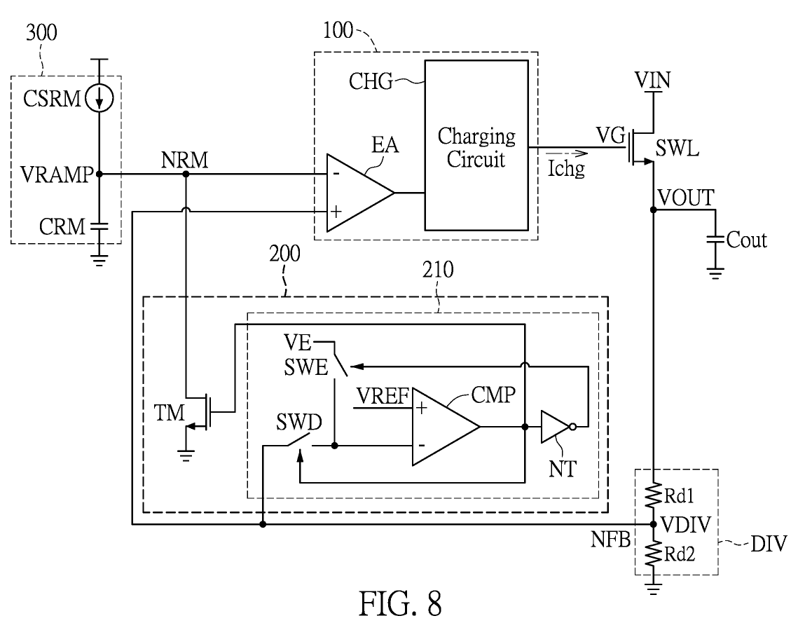

Reference is made to FIG. 8, which is a circuit diagram of an inrush current suppression circuit having a ramp voltage pull-down mechanism according to an eighth embodiment of the present disclosure.

A difference between the eighth and seventh embodiments of the present disclosure is that, in the eighth embodiment, the comparing circuit 210 shown in FIG. 8 is the same as that shown in FIG. 3. The descriptions of the eighth embodiment of the present disclosure that are the same as of the descriptions of the first to seventh embodiments of the present disclosure are not repeated herein.

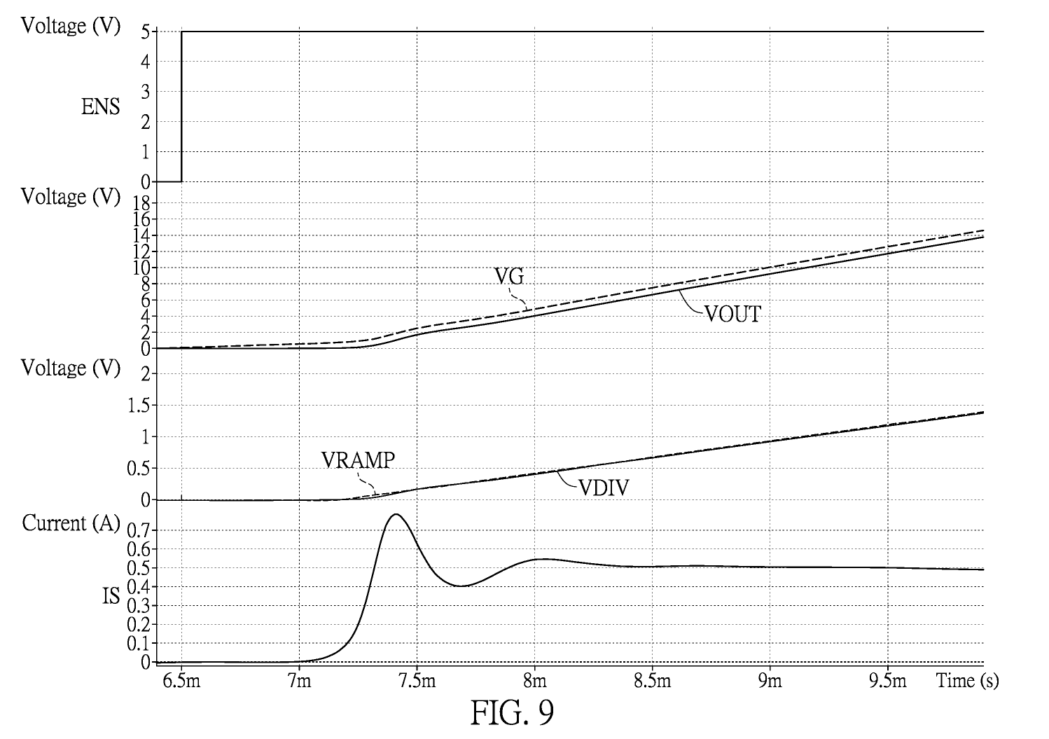

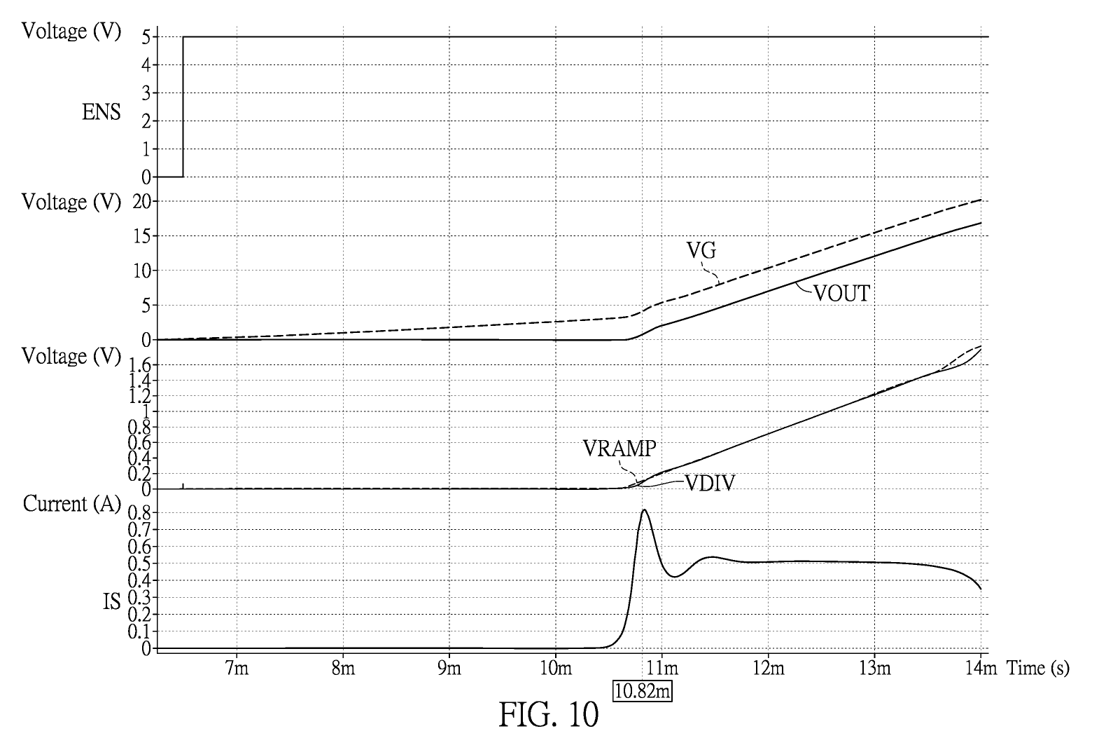

Reference is made to FIGS. 9 and 10, which are waveform diagrams of the inrush current suppression circuit having the ramp voltage pull-down mechanism according to the sixth to eighth embodiments of the present disclosure.

The ramp voltage modulating circuit 200 and the switch control circuit 100 as shown in FIGS. 1-8 are included in the inrush current suppression circuit of the present disclosure, and are applicable to the load switch SWL having any threshold voltage to prevent the inrush current from being generated in the output current of the second terminal of the load switch SWL.

For example, if the load switch SW controlled by the inrush current suppression circuit of the present disclosure has the threshold voltage of 1V, a voltage VG of the control terminal of the load switch SWL and the output voltage VOUT of the second terminal of the load switch SWL are shown in FIG. 9.

For example, if the load switch SW controlled by the inrush current suppression circuit of the present disclosure has the threshold voltage of 3.5V, the voltage VG of the control terminal of the load switch SWL and the output voltage VOUT of the second terminal of the load switch SWL are shown in FIG. 10.

As shown in FIGS. 9 and 10, a startup signal ENS transits from a low level to a high level, indicating that the inrush current suppression circuit of the present disclosure starts to perform the soft start of the load switch SWL. When the voltage VG of the control terminal of the load switch SWL is gradually increased, the output voltage VOUT of the second terminal of the load switch SWL is gradually increased, and the divided voltage VDIV of the output voltage VOUT of the second terminal of the load switch SWL is gradually increased.

It is worth noting that, when the output voltage VOUT of the second terminal of the load switch SWL is reduced to a low voltage value, the voltage difference between the divided voltage VDIV of the output voltage VOUT and the ramp voltage VRAMP is a high voltage value. At this time, the ramp voltage modulating circuit 200 of the inrush current suppression circuit of the present disclosure pulls down the ramp voltage VRAMP, for pulling down the voltage difference between the divided voltage VDIV of the output voltage VOUT and the ramp voltage VRAMP. As a result, as shown in FIGS. 9 and 10, an output current of the second terminal of the load switch SWL is quickly pulled down when the inrush current is generated.

In conclusion, the present disclosure provides the inrush current suppression circuit having the ramp voltage pull-down mechanism. In the inrush current suppression circuit of the present disclosure, when the output voltage of the load switch is initially increased, the ramp voltage modulating circuit pulls down the ramp voltage that is received from the ramp node by the switch control circuit for reducing the voltage difference between the output voltage and the ramp voltage. As a result, the switch control circuit is prevented from causing the inrush waves in the output current of the load switch in order to quickly increase the output voltage to be equal to or higher than the ramp voltage. Therefore, if the inrush current suppression circuit of the present disclosure is applied to the load switch, the switch control circuit and other external overcurrent protection devices are not triggered to perform an overcurrent protection process which causes the load switch to become ineffective or unable to be turned on.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. An inrush current suppression circuit having a ramp voltage pull-down mechanism, comprising:
a load switch, wherein a first terminal of the load switch is coupled to an input voltage;
a switch control circuit connected to a control terminal and a second terminal of the load switch, wherein the switch control circuit is connected to a ramp node, the ramp node is coupled to a ramp voltage being increased over time, and the switch control circuit is configured to output a control signal to the control terminal of the load switch according to an output voltage of the second terminal of the load switch and the ramp voltage from the ramp node; and
a ramp voltage modulating circuit including:
a modulation transistor, wherein a first terminal of the modulation transistor is connected to the ramp node, and a second terminal of the modulation transistor is grounded; and
a comparing circuit connected to the second terminal of the load switch and a control terminal of the modulation transistor, wherein the comparing circuit is configured to turn on the modulation transistor for pulling down the ramp voltage of the ramp node when the output voltage of the second terminal of the load switch is lower than a reference voltage.

2. The inrush current suppression circuit having the ramp voltage pull-down mechanism according to claim 1, wherein, when the output voltage of the second terminal of the load switch is higher than the reference voltage, the comparing circuit turns off the modulation transistor.

3. The inrush current suppression circuit having the ramp voltage pull-down mechanism according to claim 1, wherein the switch control circuit includes:
an error amplifier, wherein a first input terminal of the error amplifier is connected to the second terminal of the load switch, and a second input terminal of the error amplifier is coupled to the ramp voltage and connected to the first terminal of the modulation transistor; and
a charging circuit connected to an output terminal of the error amplifier and the control terminal of the load switch, wherein the charging circuit is configured to output a control current included in the control signal to the control terminal of the load switch according to an error amplified signal from the output terminal of the error amplifier.

4. The inrush current suppression circuit having the ramp voltage pull-down mechanism according to claim 3, further comprising:
a ramp voltage generating circuit connected to the ramp node and configured to supply the ramp voltage to the ramp node.

5. The inrush current suppression circuit having the ramp voltage pull-down mechanism according to claim 4, wherein the ramp voltage generating circuit includes:
a ramp capacitor, wherein a first terminal of the ramp capacitor is connected to the ramp node, and a second terminal of the ramp capacitor is grounded; and
a ramp current source connected to the first terminal of the ramp capacitor and configured to a ramp current to the ramp capacitor.

6. The inrush current suppression circuit having the ramp voltage pull-down mechanism according to claim 1, wherein the comparing circuit includes:
a feedback switch, wherein a first terminal of the feedback switch is connected to the second terminal of the load switch; and
a comparator, wherein a first input terminal of the comparator is connected to a second terminal of the feedback switch, a second terminal of the comparator is coupled to the reference voltage, and an output terminal of the comparator is connected to the control terminal of the modulation transistor and a control terminal of the feedback switch.

7. The inrush current suppression circuit having the ramp voltage pull-down mechanism according to claim 6, wherein the comparator further includes:
an inverter, wherein an input terminal of the inverter is connected to the output terminal of the comparator; and
an enable switch, wherein a first terminal of the enable switch is coupled to an enable voltage, a second terminal of the enable switch is connected to the first input terminal of the comparator, and a control terminal of the enable switch is connected to an output terminal of the inverter.

8. The inrush current suppression circuit having the ramp voltage pull-down mechanism according to claim 7, wherein the enable voltage is higher than the reference voltage.

9. An inrush current suppression circuit having the ramp voltage pull-down mechanism, comprising:
a load switch, wherein a first terminal of the load switch is coupled to an input voltage;
a voltage dividing circuit connected to a second terminal of the load switch and configured to divide an output voltage of the second terminal of the load switch to output a divided voltage;
a switch control circuit connected to a control terminal of the load switch, the voltage dividing circuit and a ramp node, wherein the ramp node is coupled to a ramp voltage being increased over time, and the switch control circuit is configured to output a control signal to the control terminal of the load switch according to the ramp voltage and the divided voltage; and
a ramp voltage modulating circuit including:
a modulation transistor, wherein a first terminal of the modulation transistor is connected to the ramp node, and a second terminal of the modulation transistor is grounded; and
a comparing circuit connected to the voltage dividing circuit and a control terminal of the modulation transistor, wherein the comparing circuit is configured to turn on the modulation transistor for pulling down the ramp voltage of the ramp node when the divided voltage is lower than a reference voltage.

10. The inrush current suppression circuit having the ramp voltage pull-down mechanism according to claim 9, wherein the voltage dividing circuit includes:
a first voltage dividing resistor, wherein a first terminal of the first voltage dividing resistor is connected to the second terminal of the load switch; and
a second voltage dividing resistor, wherein a first terminal of the second voltage dividing resistor is connected to a second terminal of the first voltage dividing resistor, and a second terminal of the second voltage dividing resistor is grounded;
wherein a feedback node between the first terminal of the second voltage dividing resistor and the second terminal of the first voltage dividing resistor is connected to the switch control circuit and the comparing circuit.

11. The inrush current suppression circuit having the ramp voltage pull-down mechanism according to claim 9, wherein the comparing circuit includes:
a feedback switch, wherein a first terminal of the feedback switch is connected to the voltage dividing circuit and configured to receive the divided voltage; and
a comparator, wherein a first input terminal of the comparator is connected to a second terminal of the feedback switch, a second terminal of the comparator is coupled to the reference voltage, and an output terminal of the comparator is connected to the control terminal of the modulation transistor and a control terminal of the feedback switch.

12. The inrush current suppression circuit having the ramp voltage pull-down mechanism according to claim 11, wherein the comparing circuit further includes:
an inverter, wherein an input terminal of the inverter is connected to the output terminal of the comparator; and
an enable switch, wherein a first terminal of the enable switch is coupled to an enable voltage, a second terminal of the enable switch is connected to the first input terminal of the comparator, and a control terminal of the enable switch is connected to an output terminal of the inverter.

13. The inrush current suppression circuit having the ramp voltage pull-down mechanism according to claim 12, wherein the enable voltage is higher than the reference voltage.

14. The inrush current suppression circuit having the ramp voltage pull-down mechanism according to claim 9, wherein the switch control circuit includes:
an error amplifier, wherein a first input terminal of the error amplifier is connected to the voltage dividing circuit and configured to receive the divided voltage, and a second input terminal of the error amplifier is connected to the ramp node and the first terminal of the modulation transistor; and
a charging circuit connected to an output terminal of the error amplifier, wherein the charging circuit is configured to output a control current included in the control signal to the control terminal of the load switch according to an error amplified signal from the output terminal of the error amplifier.

15. The inrush current suppression circuit having the ramp voltage pull-down mechanism according to claim 14, further comprising:
a ramp voltage generating circuit connected to the ramp node and configured to supply the ramp voltage to the ramp node.

16. The inrush current suppression circuit having the ramp voltage pull-down mechanism according to claim 15, wherein the ramp voltage generating circuit includes:
a ramp capacitor, wherein a first terminal of the ramp capacitor is connected to the ramp node and a second terminal of the ramp capacitor is grounded; and
a ramp current source connected to the first terminal of the ramp capacitor and configured to supply a ramp current to the ramp capacitor.
